(19) United States
(12) Patent Application Publication
(10) Pub. No.: US 2004/0075231 A1
(43) Pub. Date: Apr. 22, 2004

(54) Baby walker

(76) Inventors: Hung-Chung Hou, Tai-Pao City (TW); Er-Jui Chen, Feng-Shan City (TW)

Correspondence Address: LAW OFFICE OF LIAUH & ASSOC., 4224 WAIALAE AVE, STE 5-388, HONOLULU, HI, 96816

(21) Appl. No.: 10/274,675

(22) Filed: Oct. 18, 2002

(51) Int. Cl. B62B 7/00

(52) U.S. Cl. 280/87.051

(57) ABSTRACT

A baby walker allowing the child or baby moving and learning walking in a restrained area on the ground for improving safety is disclosed. The baby walker includes a top shelf, a seat assembly, a plurality of support columns and a base bracket. The seat assembly is rotatably mounted on the top shelf which is adjustably supported through the support columns on the base bracket with a suitable height. The base bracket includes a pivotal base and several wheels so as to limit the walker rotatably movable around the pivotal base.

### BACKGROUND OF THE INVENTION

### FIELD OF INVENTION

The present invention relates to a baby walker, and more particularly relates to a baby walker in which the moving range can be restrained.

Baby walkers or child walkers provide a convenient means for an infant to be entertained, before, during, and after the transition from crawling to walking. Walkers provide support for a child in a seated position, but are readily movable by the child in a standing position. Since the baby or child has no ability to control the moving direction of the walker when he or she just starts learning to move with the walker. The walker will be unintentionally moved by the baby in any direction that may cause injury or danger to the baby or child.

A conventional walker generally includes a seat for holding the baby, a connection structure connected to the seat, and a frame for supporting the connection structure. A plurality of wheels are settled at the bottom of the frame. The number of the wheels may be four, six or more. The wheels are generally free to rotate without any limitation, nor any braking mechanism is provided. Therefore, it is quite dangerous for the infants that do not have ability to control the moving direction of the walker. Accordingly, conventional walkers are generally provided with instructions and warnings advising against the use of the walker without appropriate caregiver supervision. These instructions and warnings, although practical and effective when followed, are not always observed. As a result, accidents often happen.

To solve the problem, as disclosed in the laid-open patent No. 363,375 of R.O.C., a baby walker including a curved bar with wheels at two ends was developed. The seat is fixed through a first support column to the curved bar. A second support column with a retractable wheel lets the walker movable only in the rotation area around the second support column. This structure is not firm enough, and the adjustment of leveling the seat on the support columns and retracting the wheel in the second support column may cause injury since the user has to push down buttons which are easy to harm the user's fingers.

### SUMMARY OF THE INVENTION

Accordingly, the present invention is to provide a baby walker in which the moving range can be restrained; the structure is stronger and the operation is safe enough.

A baby walker according to the present invention includes at least a top shelf, a seat assembly, a plurality of support columns and a base bracket. The seat assembly is rotatably mounted on the top shelf which is adjustably supported through the support columns on the base bracket with a suitable height. The base bracket includes a pivotal base and several wheels so as to limit the walker rotatably movable around the pivotal base.

The objectives, structure and advantages of the present invention will become more apparent from detailed descriptions provided below, with reference to the accompanying drawings.

### BRIEF DESCRIPTION OF THE DRAWINGS

FIG. 1 is an exploded view of a baby walker of the present invention showing the components thereof;

FIG. 2 is a perspective view of the present invention showing the baby walker assembled;

FIG. 3 is a partial assembly view of the present invention showing the seat assembly;

FIGS. 4A and 4B are partial views of the present invention showing the height adjustment of the support column;

FIG. 5 is a bottom view of the present invention;

FIGS. 6A and 6B are partial views of the present invention showing the function of the brake;

FIG. 7 is a functional view of the present invention showing the baby walker movable in a certain range; and

FIGS. 8A and 8B are functional views of another embodiment of brake members of the present invention.

### DETAILED DESCRIPTION OF THE INVENTION

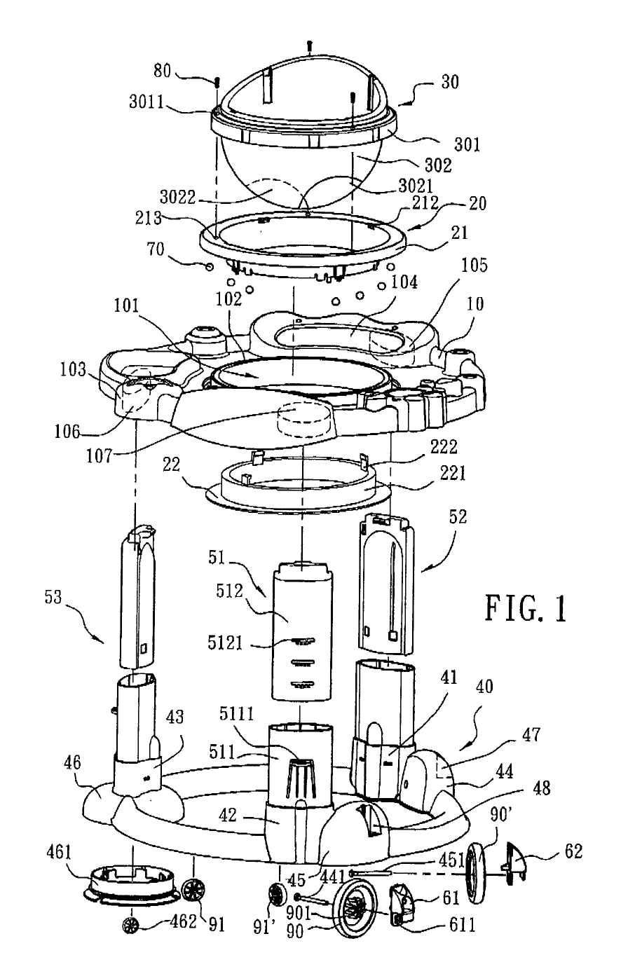

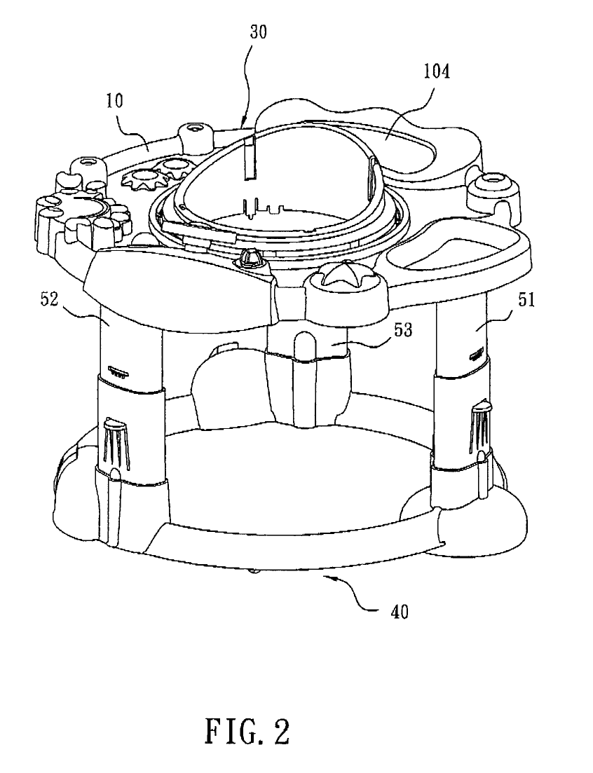

As shown in FIGS. 1 and 2, a baby walker according to the present invention includes a top shelf 10, a rotary ring set 20, a seat 30, a plurality of support columns 51, 52, 53, a base bracket 40 and brake members 61, 62.

The top shelf 10 is substantially a plate member formed with a central hole 101. An annular groove 102 is furnished on the rim of the hole 101 for holding a plurality of steel balls 70 in the rotary ring set 20 which will described later. On top of the shelf 10, there is a concave dish 104 for placing articles such as a tiny baby toy. Under the top shelf 10, three sockets 105, 106, 107 are also formed for mounting the shelf 10 on the support columns 51, 52, 53.

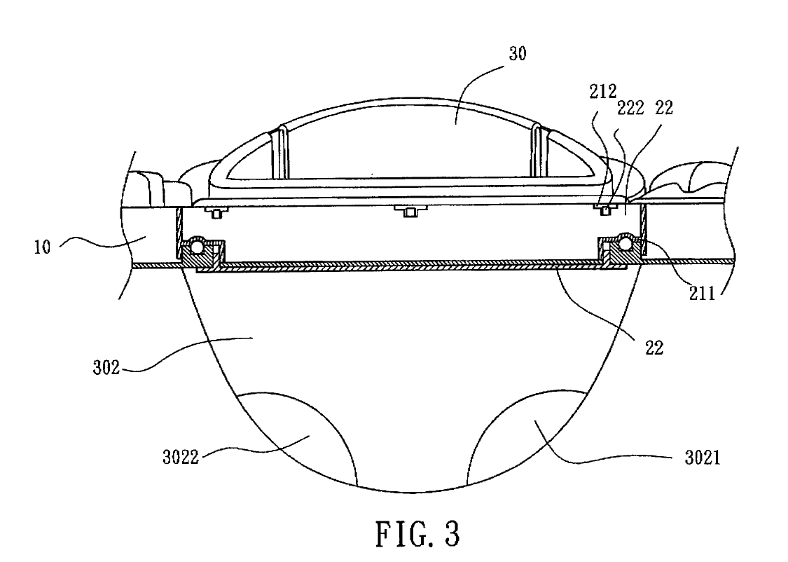

Also referring to FIG. 3, the rotary ring set 20 includes an upper ring 21 and a lower ring 22. The dimension of the upper ring 21 is almost the same as that of the hole 101. An annular groove 211 corresponding to the annular groove 102 of the top shelf 10 is also furnished on the bottom of the upper ring 21. So that the upper ring 21 is rotatably mounted on the top shelf 10 by holding the steel balls 70 rolling in the grooves 102 and 211.

The upper ring 21 is further formed with a plurality of locking holes 212 in the inner wall thereof and a plurality of screw holes 213. The dimension of the lower ring 22 is almost the same as the hole 101. A ring 221 thereof is smaller than the hole 101 for being fitted into the hole from the bottom of the hole 101. There are a plurality of hooks 222 formed on the lower ring 22 each receivable in the locking hole 212 of the upper ring 21, thereby securing the lower ring 22 to the upper ring 21, and mounting the rotary ring set 20 on the hole 101.

The seat 30 includes an annular holder 301 and a cloth-type seat 302. A plurality of holes 3011 are formed on the annular holder 301 for receiving the screws 80 that fasten the annular holder 301 to the rotary ring set 20. So that the seat 30 is rotatable along with the rotary ring set 20 relatively to the top shelf 10. The cloth-type seat 302 is fixed to the annular holder 301. Two leg openings 3021, 3022 are formed in the seat 302 for the child to put his or her legs to the ground.

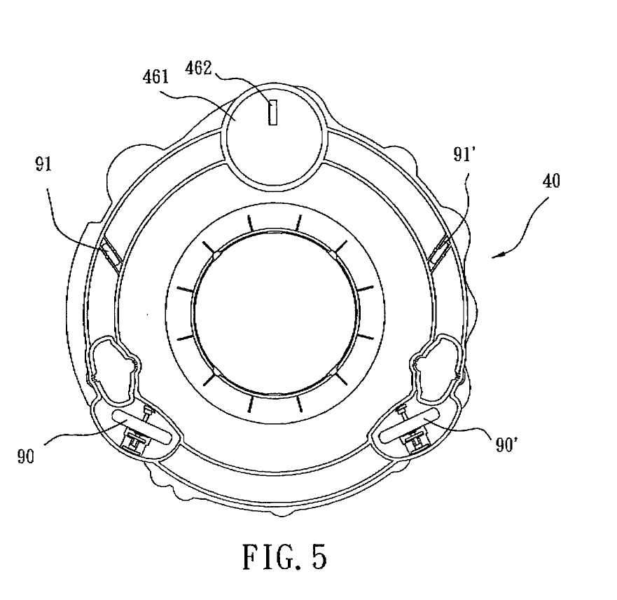

As shown in FIG. 1 and FIG. 5, the base bracket 40 is formed with three sockets 41, 42, 43, corresponding to the sockets 105, 106, 107 of the top shelf 10, for receiving the support columns 51, 52, 53. A plurality of cavities 44, 45, 46 are formed under the base bracket 40 in which two pivots 441, 451 and two primary wheels 90, 90′ are settled in the cavities 44, 45 respectively. The primary wheels 90, 90′ includes several radial spokes 901 which will be described later. Two secondary wheels 91, 91′, smaller than the primary wheels 90, 90′, are also settled under the base bracket 40. The rolling direction of the wheels 90, 90′, 91, 91′ are all in circles centering on the cavity 46. The cavity 46 is fixed with a pivotal base 461 and an auxiliary wheel 462 so that the base bracket 40 can pivotally rotate on the pivotal base 461, or move in a small area by using the auxiliary wheel 462. Two through holes 47, 48 are formed on the base bracket 40 near the primary wheels 90, 90′ for mounting the brake members 61, 62.

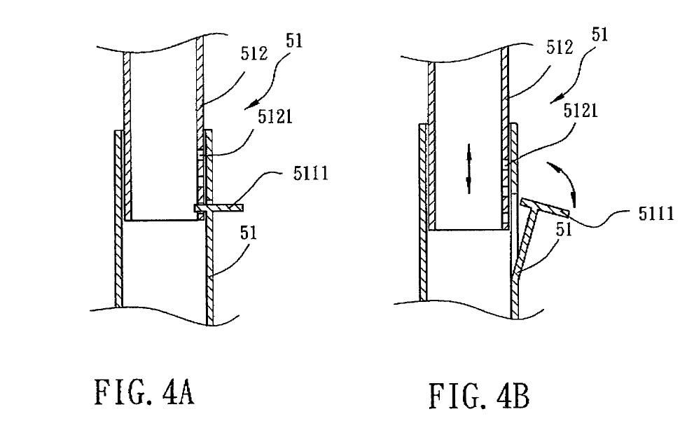

A plurality of support columns 51, 52, 53 are mounted between the sockets 105, 106, 107 of the top shelf 10 and the sockets 41, 42, 43 of the base bracket 40, so as to support the top shelf 10 on the base bracket 40 with a suitable height for accommodating to the baby. Also referring to FIGS. 4A, 4B, each of the support columns 51, 52, 53 includes an outer tube 511 and an inner tube 512 slidably mounted with each other. The lower end of the outer tube 511 is fixed to the socket 41, 42 or 43 of the base bracket 40. The upper end of the inner tube 512 is fixed to the socket 105, 106 or 107 of the top shelf 10. The diameter of the inner tube 512 is a little smaller than that of the outer tube 511. A latch 5111 is formed on the outer tube 511, which is selectively engageable to one of a plurality of holes 5121 formed on the inner tube 512 so as to adjust the relative position of the tubes 511, 512 and adjust the height of the support columns 51, 52, 53.

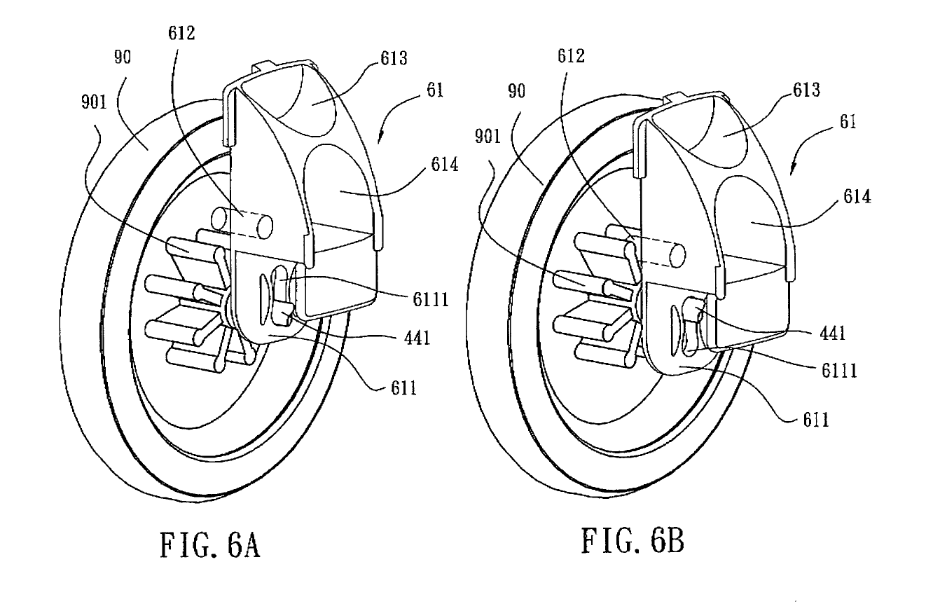

As shown in FIGS. 1 and 6A, 6B, the brake members 61, 62 are movably mounted in the through holes 47, 48 of the base bracket 40. Each of the brake members 61, 62 is formed with a mounting portion 611 in which a slot 6111 is formed. The pivot 441 (or 451) passes through the slot 6111 and a center hole of the wheel 90 (90′) for pivotally mounting the wheel 90 (90′) in the cavity 45 (44). The slot 6111 is a longitudinal hole with a narrower portion in the middle so that the brake member 61, 62 can be selectively placed in two positions, as a releasing position and a locking position, relative to the pivot 441, 451. That is, when in the releasing position, a stopper 612 formed at the back of the brake member 61, 62 will be released from the spokes 901 of the wheel 90, 90′ to allow the wheel to rotate; and, when in the locking position, the stopper 612 will move into the spokes 901 of the wheel 90, 90′ for braking the wheel 90, 90′. A handle with a push portion 613 and a pull portion 614 is formed on the brake members 61, 62 for an easier operation.

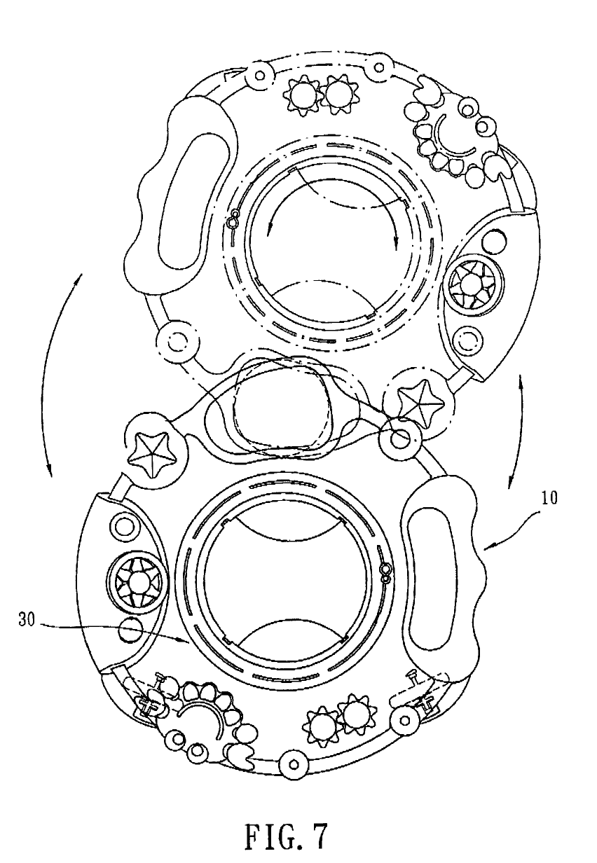

As shown in FIG. 7, the baby walker is movable in an area centering on the pivotal base 461 of the base bracket 40 by rotation of the primary and secondary wheels 90, 90′, 91 and 91′. So that the moving range of the baby walker is suitably limited to ensure safety of the baby.

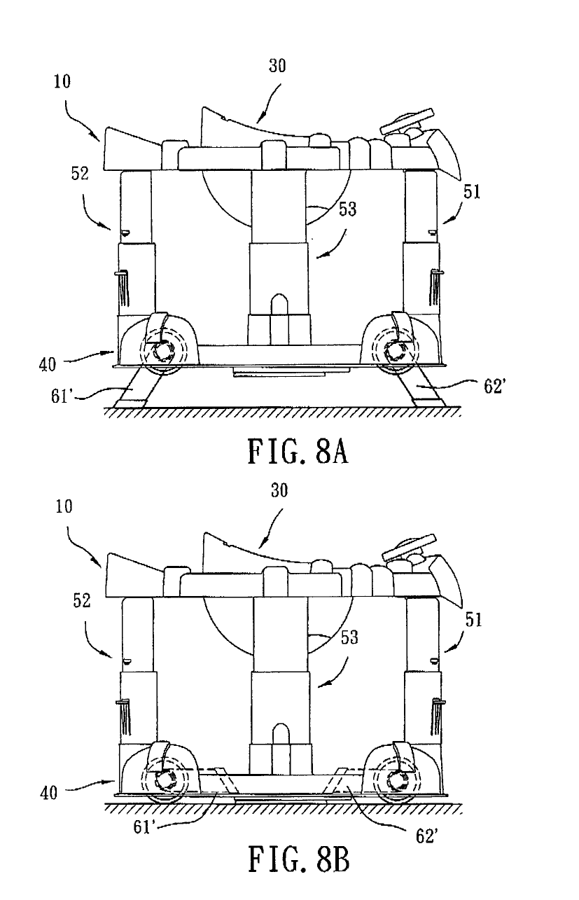

FIGS. 8A and 8B illustrate another embodiment of brake members of the present invention. The brake members 61′, 62′ are movable elements each can be selectively positioned in a storage position and a stand position. In the stand position as shown in FIG. 8A, the brake members 61′, 62′ lift the base bracket 40 off the ground so as to prevent the walker from moving. In the storage position as shown in FIG. 8B, the brake members 61′, 62′ are lifted up to the bottom of the base bracket 40 to make the walker movable on the ground.

While the invention has been described in its preferred embodiments, it is to be understood that the words which have been used are words of description rather than limitation and that changes within the purview of the appended claims may be made without departing from the true scope and spirit of the invention.

1. A baby walker for supporting a baby movable on a ground, comprising:
a top shelf, for supporting the body of the baby, a rotary ring set is mounted around a central hole of the top shelf;
a seat assembly fixedly mounted on the rotary ring set for carrying the baby and to be rotatable with the rotary ring set relative to the top shelf;
a base bracket, comprising a plurality of wheels mounted thereunder, and a pivotal base, wherein the pivotal base is structured so that it will be pivotably standing on a fixed position on the ground by a weight of the baby, and the plurality of wheels are structured so that they can travel along one or more fictitious concentric circles centered at the pivotal base so as to allow the walker to be rotatably movable around the pivotal bases; and
a plurality of support columns, for supporting the top shelf with a suitable height upon the base bracket.

2. A baby walker as recited in claim 1 wherein an annular groove is furnished on the rim of the central hole for holding a plurality of steel balls rolling therein.

3. A baby walker as recited in claim 2 wherein the rotary ring set comprises:
an upper ring, furnished on the bottom thereof with an annular groove corresponding to the annular groove of the top shelf, for holding the steel balls rolling therein; and
a lower ring, settled under the central hole and coupled with said upper ring so as to make the rotary ring set rotatable relative to the top shelf.

4. A baby walker as recited in claim 3 wherein the seat assembly comprises:
an annular holder, fixed to the rotary ring set; and
a cloth-type seat, fixed to the annular holder, and formed with at least two leg openings for the baby to put legs to the ground.

5. A baby walker as recited in claim 1 wherein each of the support columns comprises:
an outer tube, fixed with one end to the base bracket, having a movable latch formed thereon; and
an inner tube, slidably mounted with one end in said outer tube, and fixed with another end to the top shelf, having a plurality of holes formed thereon for selectively engaging with said latch of the outer tube so as to adjust the height of the support column.

6. A baby walker as recited in claim 1 wherein a concave dish is formed on top of the top shelf for placing articles for the baby.

7. A baby walker as recited in claim 1 wherein the pivotal base further comprises an auxiliary wheel.

8. A baby walker for supporting a baby movable on a ground, comprising:
a top shelf, for supporting the body of the baby, a rotary ring set is mounted around a central hole of the top shelf;
a seat assembly fixedly mounted on the rotary ring set for carrying the baby and to be rotatable with the rotary ring set relative to the top shelf;
a base bracket, comprising a plurality of wheels mounted thereunder, and a pivotal base, wherein the pivotal base is structured so that it will be pivotably standing on a fixed position on the ground by a weight of the baby, and the plurality of wheels are structured so that they can travel along one or more fictitious concentric circles centered at the pivotal base so as to allow the walker to be rotatably movable around the pivotal bases;
at least a brake member, movably mounted aside at least a wheel on said base bracket, to be selectively placed in a locking position to brake the wheel, and a releasing position to release the wheel, and
a plurality of support columns, for supporting the top shelf with a suitable height upon the base bracket.

9. A baby walker as recited in claim 8 wherein an annular groove is furnished on the rim of the central hole for holding a plurality of steel balls rolling therein.

10. A baby walker as recited in claim 9 wherein the rotary ring set comprises:
an upper ring, furnished on the bottom thereof with an annular groove corresponding to the annular groove of the top shelf, for holding the steel balls rolling therein; and
a lower ring, settled under the central hole and coupled with said upper ring so as to make the rotary ring set rotatable relative to the top shelf.

11. A baby walker as recited in claim 10 wherein the seat assembly comprises:
an annular holder, fixed to the rotary ring set; and
a cloth-type seat, fixed to the annular holder, and formed with at least two leg openings for the baby to put legs to the ground.

12. A baby walker as recited in claim 8 wherein each of the support columns comprises:
an outer tube, fixed with one end to the base bracket, having a movable latch formed thereon; and
an inner tube, slidably mounted with one end in the outer tube, and fixed with another end to the top shelf, having a plurality of holes formed thereon for selectively engaging with the latch of the outer tube so as to adjust the height of the support column.

13. A baby walker as recited in claim 8 wherein a concave dish is formed on top of the top shelf for placing articles for the baby.

14. A baby walker as recited in claim 8 wherein each of the wheels is pivotally mounted under the base bracket with a pivot.

15. A baby walker as recited in claim 8 wherein the wheel to be braked is formed with a plurality of radial spokes.

16. A baby walker as recited in claim 8 wherein the base bracket is formed with at least a through hole for mounting the brake member.

17. A baby walker as recited in claim 14 wherein the brake member is movably mounted on the pivot.

18. A baby walker as recited in claim 17 wherein the brake member is formed with a slot for the pivot to pass through.

19. A baby walker as recited in claim 15 wherein the brake member is formed with a stopper to be released from the spokes of the wheel to allow the wheel rotating when the brake member is in the releasing position; and to move into the spokes for braking the wheel when the brake member is in the locking position.

20. A baby walker for supporting a baby movable on a ground, comprising:
a top shelf, for supporting the body of the baby, a rotary ring set is mounted around a central hole of the top shelf;
a seat assembly fixedly mounted on the rotary ring set for carrying the baby and to be rotatable with the rotary ring set relative to the top shelf;
a base bracket, comprising a plurality of wheels mounted thereunder, the plurality of wheels are structured so that one of the wheels is fixed on the ground, the rest of the wheels can travel along one or more fictitious concentric circles centered at the pivotal base so as to allow the walker to be rotatably movable around the pivotal bases;
at least a brake member, movably mounted under said base bracket, to be selectively placed in a stand position to lift up the base bracket and the wheels, and a storage position to lay down the base bracket and the wheels to the ground, and
a plurality of support columns, for supporting the top shelf with a suitable height upon the base bracket.
